(19) United States
(12) Patent Application Publication
(10) Pub. No.: US 2023/0069457 A1
(43) Pub. Date: Mar. 2, 2023

(54) ELECTRODES COMPRISING A SOLID SOLUTION AND METHODS OF FORMING THE ELECTRODES

(71) Applicant: Battelle Energy Alliance, LLC, Idaho Falls, ID (US)

(72) Inventor: Prabhat K. Tripathy, Idaho Falls, ID (US)

(21) Appl. No.: 17/446,692

(22) Filed: Sep. 1, 2021

(51) Int. Cl. H01B 5/14; C25D 5/50; H01B 1/02

(52) U.S. Cl. CPC H01B 5/14; C25D 5/50; H01B 1/02

(57) ABSTRACT

An electrode comprising a substrate; a metal layer on the substrate; and a solid solution between the metal layer and the substrate. A method of forming an electrode comprising forming a molten salt bath, plating, from the molten salt bath, a metal onto a substrate, and annealing the metal and the substrate to form an electrode comprising a solid solution between the metal and the substrate, wherein the electrode is substantially free of intermetallic phases. A method of forming an electrode comprising forming, on a substrate, a metal layer using digital light processing and annealing the substrate and the metal layer to form a solid solution between the substrate and the metal layer, wherein the electrode is substantially free of intermetallic phases.

### STATEMENT REGARDING FEDERALLY SPONSORED RESEARCH OR DEVELOPMENT

This invention was made with government support under Contract Number DE-AC07-05-ID14517 awarded by the United States Department of Energy. The government has certain rights in the invention.

### FIELD

Embodiments of the disclosure relate generally to electrodes. Specifically, embodiments of the disclosure relate to electrodes comprising a solid solution between a substrate and a metal layer. The electrode materials are noble metal-free or use reduced amounts of noble metals.

### BACKGROUND

Electrodes for solar energy and other clean energy applications may use a variety of materials. One group of materials is noble metals, such as platinum and gold, which are valued for their efficiency and inertness. However, the costs of such materials are high and their inertness may be less than previously believed, especially over longer lifetimes as components in solar cells and other applications. Noble metals have high embodied energy. For example, primary extraction and processing of gold and platinum have embodied energy values of 252 GJ/kg and 271 GJ/kg, respectively. The high embodied energy may make the use of noble metals as electrodes costly, especially when deployed as monolithic materials. Solar cell lifespans are currently being considered for twenty years or longer. Accordingly, the resistance to diffusion and degradation over longer periods of time is increasingly relevant to the performance of the electrode materials.

In recent years, cost-effective manufacturing processes for recovering precious metals and removing toxic elements (e.g. toxic metals) from waste products, such as photovoltaic, radioactive, battery, and manufacturing wastes are being investigated. In some cases, the metals are present as oxides. Such recovery and removal processes would benefit from developing less expensive, yet inert, electrodes.

### BRIEF SUMMARY

Embodiments disclosed herein include an electrode comprising a substrate, a metal layer on the substrate, and a solid solution between the metal layer and the substrate.

In additional embodiments, a method of forming an electrode comprises forming a molten salt bath. A metal is plated onto a substrate from a molten salt bath and the metal and the substrate are annealed to form a solid solution between the metal and the substrate. The electrode is substantially free of intermetallic phases.

In further embodiments, a method of forming an electrode comprises forming, on a substrate, a metal layer using digital light processing. The substrate and the metal layer are annealed to form a solid solution between the substrate and the metal layer, wherein the electrode is substantially free of intermetallic phases.

### BRIEF DESCRIPTION OF THE DRAWINGS

FIG. 1 shows a schematic of an electrode in accordance with embodiments of the disclosure;

FIG. 2 is a flow diagram showing a process in accordance with embodiments of the disclosure;

FIG. 3 is a flow diagram showing a process in accordance with embodiments of the disclosure; and

FIG. 4 is a simplified schematic of an electroplating cell, in accordance with embodiments of the disclosure.

### DETAILED DESCRIPTION

Illustrations presented herein are not meant to be actual views of any particular material, component, or system, but are merely idealized representations that are employed to describe embodiments of the disclosure.

The following description provides specific details, such as material types, dimensions, and processing conditions in order to provide a thorough description of embodiments of the disclosure. However, a person of ordinary skill in the art will understand that the embodiments of the disclosure may be practiced without employing these specific details. Indeed, the embodiments of the disclosure may be practiced in conjunction with conventional fabrication techniques employed in the industry. In addition, the description provided below does not form a complete process flow, apparatus, system or method for forming noble metal-free electrodes. Only those process acts and structures necessary to understand the embodiments of the disclosure are described in detail below. Additional acts to form the noble metal-free electrodes or electrodes with reduced amounts of noble metals may be performed by conventional techniques. Also note, any drawings accompanying the present application are for illustrative purposes only, and are thus not drawn to scale. Additionally, elements common between figures may retain the same numerical designation.

As used herein, the term “noble metal” means and includes a metal including at least one of ruthenium, osmium, rhodium, rhenium, iridium, palladium, platinum, gold, and silver.

As used herein, the term “noble metal-free” means compositions which do not contain a noble metal.

As used herein, the term “platinum group metal” (PGM) means and includes a metal including at least one of ruthenium, osmium, rhodium, iridium, palladium, and platinum.

As used herein, the term “solid solution” means and includes a mixture of solid materials which form a continuous range of chemical compositions when mixed. The term solid solution contrasts with intermetallic compounds which form discrete compositions.

As used herein, the term “substantially” means and includes the variation a person of ordinary skill in the art would consider acceptable for the operation of the claimed process or device. A value may be 90%, 95%, 98%, 99%, or 99.9% of a specified value. When something is described as “substantially free” of a material, it means that the material may be found as trace impurities but is not an added component of the composition. For example, a molten salt plating bath may be substantially free of chlorides but still contain trace amounts as contaminants from the metal halides which makes up the electrolyte.

Electrodes (both metals and alloys) may be formed by a “coating-cum-annealing” process, which promotes the formation of diffusion bonded materials and imparts robustness to a wide range of substrate materials. Such a process may be used to form both monolithic and alloy-based electrodes for use in corrosive, oxidizing, and/or reducing environments.

The electrodes include an interlayer between a substrate and a metal layer. The interlayer comprises a solid solution between the material of the substrate and the material of the metal layer. The interlayer may provide chemical resistance to the electrodes, impeding chemical attack of the substrate.

The interlayer may be formed during molten salt electroplating of a metal coating onto the substrate. The interlayer may be formed during an anneal after forming the metal coating (e.g., the metal layer) on the substrate. The interlayer provides robustness to the electrodes. In some embodiments, the interlayer is substantially free of intermetallic phases.

The electrodes according to embodiments of the disclosure exhibit excellent inertness without using noble metals. The electrodes may, therefore, be substantially free of noble metals. The electrodes may combine noble metals with non-noble metals or metalloids. The electrodes may also be formed without using high temperatures and/or high vacuum conditions, resulting in a more economical process. The processes may include molten salt plating baths operated at a temperature of from about 350° C. to about 450° C., annealing operations performed in inert atmosphere at a temperature of from about 500° C. to about 600° C., and digital light processing (DLP) at, for example, room temperature, to prepare printed electrodes.

The processes may be inexpensive manufacturing process for forming electrodes and other metallic materials for use in electrochemical device technologies, such as solar cells, fuel cells, and electrochemical cells. In addition to being used as anodes or cathodes of the electrochemical cells, the materials may also be used as interconnectors of electrochemical cells.

Three types of electrodes may be produced with the coating-cum-annealing approach. The first type is composite plated electrodes. The second type is cast electrodes. The third type is printed electrodes. Each of these electrodes are prepared, i.e., coated, as described below and then subject to anneal as described below.

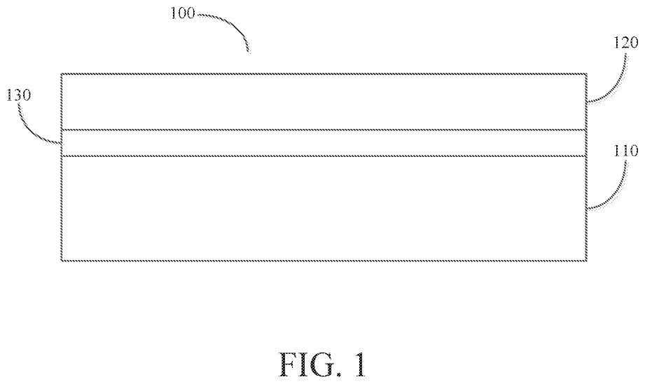

FIG. 1 shows a schematic of an electrode 100 according to embodiments of the disclosure. The electrode 100 includes a substrate 110 and a metal layer 120, with a solid solution 130 between the substrate 110 and the metal layer 120. The electrode 100 may be formed as a composite plated electrode, a cast electrode, or a printed electrode.

The substrate 110 may be a metal, for example, aluminum, iron, titanium, steel, copper, nickel, molybdenum, etc. The substrate 110 may, alternatively, be a metalloid, for example, silicon. The substrate 110 may be conductive so as to facilitate electrodeposition of metal onto the surface of the substrate 110. However, non-conductive substrates 110 may be used for compatibility with the DLP process. The substrate 110 may be substantially planar or substantially non-planar. Substrates 110 with non-planar shape may be modified with the casting process. Substrates 110 with non-planar shape may be printed with the DLP process. The substrate 110 may be substantially flat, for example, the substrate 110 may be a layer (e.g., a strip) of material. The substrate 110 may be a non-conductive material when the metal layer 120 of the electrode 100 is formed by digital light processing.

The metal layer 120 is formed on the substrate 110. The metal layer 120 may be formed by plating the metal layer 120 onto the substrate 110. The metal layer may be formed using electrodeposition onto the substrate 110. Alternatively, the metal layer may be formed on the substrate 110 using digital light processing (DLP). The metal layer may include a transition metal, a platinum group metal, or a rare earth element.

The metal layer 120 of the composite plated electrode or the cast electrode may include a transition metal, a platinum group metal, or a rare earth element that may be plated from a molten salt plating bath. The metal layer 120 may include, but is not limited to, aluminum, chromium, copper, nickel, titanium, neodymium, or another metal. Copper, nickel, and aluminum alloys have embodied energies in the range of 60 MJ/kg to 240 MJ/kg, which are more than three orders of magnitude lower than the embodied energy values of 252 GJ/kg and 271 GJ/kg of gold and platinum, respectively. The substrate of the composite plated electrode may be plated using the molten salt plating bath. In some embodiments, the metal layer 120 includes titanium, aluminum, or neodymium.

For the printed electrode, the metal layer 120 may be printed onto the substrate 110 using digital light processing. Conductivity may be less important for the substrate 110 when the metal layer 120 is formed by digital light processing. For example, the digital light processing may form the metal layer 120 directly onto a non-conductive or minimally conductive substrate 110. The digital light processed layer may be copper, nickel, or molybdenum. In an example, the digital light processed metal layer 120 is in the form of a green part which is subsequently sintered to form a desired metal structure. The green part may be fused with the substrate 110 during the sintering process. The green part may be non-uniform in thickness. The green part may include a number of layers to conform to the substrate 110. Alternatively, the green part may be fused with the substrate 110 in an annealing operation after the sintering process has been performed. The sintering process may be combined with the annealing process and conducted in a single oven as part of a shared sequence. The sintering process may be conducted first and then the annealing process conducted to form the solid solution 130 between the substrate 110 and the sintered metal layer 120. The metal layer 120 with the printed electrodes may be limited to materials which are printable with the digital light processing system. Other metals may be processed with the digital light processing system including iron, aluminum, steel, and Inconel. Suitable oxides for DLP include aluminum oxide, zirconium oxide, titanium oxide, etc. These may be printed and then reduced to their constituent metal in a molten salt bath or heating them in a reducing atmosphere, such as pure hydrogen, an argon-hydrogen mixture, or an argon-helium mixture.

The solid solution 130 is in between the metal layer 120 and the substrate 110 and contains a combination of the materials of the metal layer 120 and the substrate 110. The solid solution 130 may be formed by diffusion during annealing of the electrode 100. The solid solution 130 may be partially formed during plating of the metal layer 120 onto the substrate 110. The solid solution 130 may provide a corrosion barrier protecting the substrate 110 from a corrosive fluid. The electrode 100, therefore, includes the substrate 110 and the metal layer 120 connected by the solid solution 130.

The interlayer may be a solid solution 130 of two or more materials. In some embodiments, the interlayer is a solid solution 130 of two metals. Alternatively, the interlayer may be a solid solution 130 of a metal and a metalloid, e.g., silicon. In some embodiments, the interlayer is a solid solution 130 of aluminum and silicon.

The interlayer may be substantially free of intermetallic compounds. The lack of intermetallic compounds may increase the lifetime of the associated electrode 100. The interlayer may be partially formed during plating in the molten salt plating bath. The interlayer is then enlarged and/or homogenized during the post-plating anneal. The anneal time and anneal temperature may be selected to increase formation of the solid solution 130 between the components of the electrode 100, such as between the substrate 110 and the metal layer 120. Similarly, the anneal time and anneal temperature may be selected to inhibit formation of intermetallic compounds between the components of the electrode 100.

The composite plated electrodes and cast electrodes may be formed using a molten salt plating bath. A description of such a molten salt plating bath is provided herein. It is understood that variations on the described system would be able to perform the described operations and provide the described plating.

Composite plated electrodes are plated from the molten salt plating bath that contains the metal or metals to be plated, e.g., in the form of a functional electrolyte. The metal is formed on a substrate 110. The composite plated electrode is then annealed to form a desired alloy of the metal.

The composite plated electrode may include, but is not limited to, Al—Fe, Ti—Al, Si—Al, Fe—Cr, and Fe—Cr—Ni. By way of example only, an iron substrate may be plated with aluminum to produce an Al—Fe electrode. Alternatively, a silicon substrate may be plated with aluminum to form a Si—Al electrode. An aluminum substrate may be plated with titanium or a titanium substrate may be plated with aluminum to form a Ti—Al electrode. An iron substrate may be chromium plated to form a Fe—Cr electrode. In an example, an iron substrate is plated with chromium and nickel from the molten salt bath to form a Fe—Cr—Ni electrode. The iron substrate may be plated with chromium separately from the nickel. The iron substrate may be plated with chromium and nickel simultaneously. In either approach, the subsequent annealing may be used to homogenize the resulting plated structure and form a solid solution 130 between the plated material and the substrate 110.

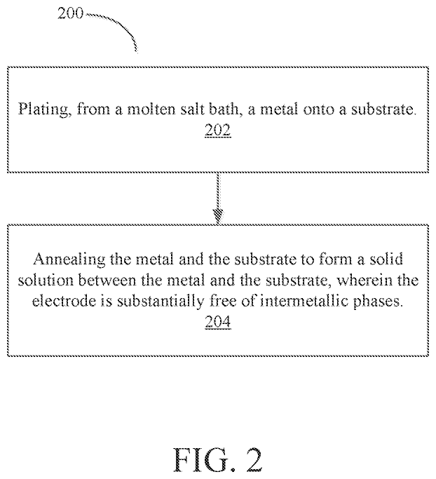

FIG. 2 is a flow diagram showing a process 200 according to embodiments of the disclosure. The process 200 includes the act 202 of plating, from the molten salt bath, the metal onto the substrate 110. The process 200 also includes the act 204 of annealing the metal and the substrate 110 to form the solid solution 130 between the metal and the substrate 110, wherein the electrode 100 is substantially free of intermetallic phases.

The process 200 includes the act 202 which includes plating, from the molten salt bath, the metal onto the substrate 110. In some embodiments, the substrate 110 is silicon and the metal is aluminum. In other embodiments, the substrate 110 includes iron (e.g., iron or steel) and the metal includes aluminum or chromium. Therefore, the electrode 100 may be substantially free of noble metals. This may reduce the cost of the electrode 100 or reduce the price volatility of the electrode materials. Similarly, the use of metal salts to produce the electrodes may reduce the price volatility of the materials used to produce the electrode 100.

The process 200 also includes the act 204 of annealing the metal and the substrate 110 to form the solid solution 130 between the metal and the substrate 110. The electrode is substantially free of intermetallic phases. The annealing may be conducted in an inert atmosphere or in a vacuum. The annealing may be conducted at a temperature between about 500° C. and about 600° C. for from about 8 hours to about 16 hours. In some embodiments, the annealing is conducted for about 12 hours. The annealing may serve to form the solid solution 130 between the substrate 110 and the metal layer 120. The solid solution 130 may provide protection to the substrate 110 from corrosion.

The molten salt plating bath may include an auxiliary electrolyte and a functional electrolyte. The auxiliary electrolyte may include lithium salt, sodium salt, potassium salt, cesium salt, and/or rubidium salt. These salts may be bromides, iodides, fluorides, and/or mixtures thereof. These salts may form a eutectic mixture. For example, the auxiliary electrolyte salts may be present in the following molar ratio: 56.1 LiBr-18.9 KBr-25 CsBr. Added to the auxiliary electrolyte is the metal salt of the metal or metals to be plated, i.e., the functional electrolyte. The functional electrolyte may be a halide (e.g., a bromide) of the desired metal. The auxiliary salt mixture may make up about 10 wt. % of the molten salt plating bath. The auxiliary salt mixture may be up to about 30 wt. % or about 40 wt. % of the molten salt plating bath. The remainder of the molten salt plating bath may be the functional electrolyte. In some embodiments, the auxiliary electrolyte makes up about 20 wt. % of the molten salt plating bath and the functional electrolyte makes up about 80 wt. % of the molten salt plating bath. Higher functional electrolyte concentrations have been found to support dense, adherent deposits of the plated metal.

The functional electrolyte is a metal salt of the metal to be plated from the molten salt plating bath. The functional electrolyte may be a metal halide, e.g., a metal chloride, a metal bromide, a metal iodide, a metal fluoride, or mixtures thereof. For example, the functional electrolyte may be aluminum bromide (AlBr₃) and/or aluminum iodide (AlI₃) to form an aluminum molten salt plating bath. Similarly, the functional electrolyte may be a titanium salt, e.g., TiBr₄, when plating titanium. In some examples, the use of a bromide or iodide for the functional electrolyte provides robustness to temperature for the molten salt plating bath. Bromides and iodides may have higher decomposition and/or sublimation temperatures compared with, for example, chlorides of the same metals.

The molten salt plating bath may be heated to about 350° C. to about 450° C. The plating bath may be heated higher to form the eutectic mixture of auxiliary salts. In some embodiments, the plating bath is heated to a higher temperature and then cooled before adding the functional electrolyte. It may be useful, in some embodiments, to avoid chloride as the functional electrolyte due to the tendency for the metal chlorides to sublimate. Instead, bromides and/or iodides may provide improved stability of the metal salt of the functional electrolyte in the molten salt plating bath. In contrast, the use of metal chlorides may result in sublimation of the active species of the functional electrolyte. For example, the loss of aluminum trichloride (AlCl₃) was greater than 80% at a temperature under 200° C. In contrast, aluminum tribromide (AlBr₃) was much more stable in molten salt baths, even at higher temperatures, due to the thermal stability of the bromide. The bromide electroplating technique can also be used to fabricate a host of other engineering alloys, containing base metals, transition metals, and/or rare earth elements. In all of these alloys, the functional electrolyte is the bromide salt of the coating element (e.g., TiBr₄, RuBr₃, NdBr₃).

The plating of the metal onto the substrate 110 may be performed for from about 30 to about 120 minutes. The time may be shorter, for example, when a thin layer of plated material is desired. The time may be longer, for example, when a thicker layer of plated material is desired. Generally speaking, plating thickness may be a function of charge applied to the cathode and efficiency. Charge, in turn, may be a function of time and current.

The plating of the metal may be performed at a temperature of from about 350° C. to about 450° C. This temperature range is generally sufficient to combine the functional electrolyte with the auxiliary electrolyte. The use of this lower temperature allows for the use of a variety of substrates 110. The substrates 110 may have a melting temperature above the temperature of the molten salt plating bath.

Plating of the metal may be conducted at a current density of about 0.1 A/cm² to about 0.5 A/cm². In some embodiments, the current density may be lower for slower deposition. In other embodiments, the current density may be higher than 0.5 A/cm², depending on the particular composition and parameters of the plating bath. Plating thickness may be a function of charge, which is a function of current and time. Thus, higher current densities may produce thicker plating of the metal on the substrate in a given amount of time. Similarly, lower current densities may produce thinner plating in a given amount of time. However, high current densities have the potential to outstrip the diffusion rate of metal ions from the molten salt bath to the surface of the plated electrode, undesirably causing dendritic areas of the plating. By controlling the components of the molten salt plating bath and plating parameters, dense, adherent plating of the metal on the substrate may be achieved.

The plating of the metal may be conducted by a pulse plating process, where the applied potential at a working electrode (e.g., the substrate 110) is reversed periodically. For example, the plating may apply 0.5 A/cm² (cathodic) to the working electrode for five minutes and then apply 0.5 A/cm² (anodic) for a period of time, e.g., a minute, five minutes. This process may be repeated for the duration of the plating with periods of cathodic potential at the working electrode broken up with periods of anodic potential. In some cases, the use of pulsed plating helps to form a compact, adherent plated coating (e.g., the metal) on the surface of the substrate 110. The use of pulsed plating may also allow for more time for diffusion to the working electrode of the species to be plated. The use of pulsed plating may help avoid formation of loose and/or dendritic deposits. Pulsed plating provides multiple additional variables to control the plating process, which enable additional control but may also require additional time and experimentation for a given plating setup for a given geometry of a part.

Another variable that can be adjusted is the agitation in the molten salt plating bath. Agitation can take two main forms. One is bath agitation, i.e., the movement of the molten salt in the molten salt plating bath. The second is part agitation, i.e., the movement of the substrate 110 in the molten salt plating bath. Both types of agitation serve to reduce a boundary film that may form around the substrate(s) in the molten salt plating bath. In some embodiments, agitation is utilized to allow for higher current densities while plating. In other embodiments, it may be sufficient to plate “low (current density) and slow (for a longer time)” to produce a suitable plating deposit on the part. Agitation may help reduce the impact of features on the plated part from impacting the plating. For example, the use of agitation may reduce the impact of ridges, edges, and similar features on the plated part by normalizing the ion concentration across the surface of the part.

The plating bath utilizes a counter electrode (anode). The counter electrode may be a monolithic piece of metal of the same type being plated as the coating at the cathode. This may help to keep the concentration of metal ions in the molten salt plating bath more consistent by replenishing the molten salt plating bath during use with ions dissolved from the anode. The counter electrode may provide metal ions to the molten salt plating bath of the type being plated at the cathode. For example, the counter electrode may be aluminum when plating aluminum on the cathode. The counter electrode may be chromium, nickel, titanium, zirconium, etc. depending on the material being plated from the molten salt bath. When an alloy is being plated, the counter electrode may be one element of the alloy or may be the alloy. The electroplating process may also be used to fabricate other materials, such as Al—Si, Al-coated Ti, and Ti-coated Al.

The plating bath may optionally use a reference electrode. For instance, the reference electrode may be a glassy carbon rod. The reference electrode may be silver/silver chloride, platinum wire, nickel/nickel oxide or other suitable material. The reference electrode may be connected to a potentiostat/galvanostat which monitors and/or controls the voltage and/or current applied between the workpiece or the cathode and the counter electrode.

After plating, the working electrode (e.g., substrate 110) may be removed in an inert atmosphere, e.g., an argon atmosphere of a glove box, and allowed to cool. Once cooled, the electrode and/or workpiece may be washed, e.g., with water, ethyl alcohol and acetone successively to remove any adhered salts. This approach may avoid or reduce oxidation of the electrode being formed due to interaction with oxygen while the electrode is hot. The washed electrodes may then be subjected to an annealing step which is described below.

In some embodiments, diffusion occurs during plating where material of the plated material diffuses into the substrate and the material of the substrate diffuses into the plated material. The diffusion may be increased by annealing after plating. The diffusion may form the interlayer between the plated material and the substrate 110. The interlayer may be a solid solution 130 of the plated material and the substrate 110. The interlayer may be substantially free of intermetallic compounds. The interlayer may serve to protect the substrate 110 from the environment. The intermetallic compounds may be limited by controlling the annealing time and temperature.

The annealing may be performed in an inert atmosphere. The inert atmosphere may include noble gases, e.g. argon and/or helium. The inert atmosphere may limit interaction with oxidizing species, especially oxygen.

The cast electrodes may be formed by reacting the substrate 110 with one or more components in the molten salt plating bath. For example, an electrode may include a monolithic substrate 110 of a first material. The substrate 110 may be placed in the molten salt bath containing a lithium containing salt or a calcium containing salt. An anode of a system (described below) may react with the lithium containing salt to form lithium containing compounds. Similarly, the anode may react with the calcium containing salt to form calcium containing compounds in the molten salt bath. The formed calcium and/or lithium compounds on the surface of the anode may be used as the counter electrode subsequently. In other embodiments, the cathode of the system generates oxygen which reacts with lithium and calcium and forms a coating on the anode surface. In other embodiments, the cathode of the system generates oxygen species which react with the cast electrode substrate 110 at the cathode. The ions generated at the anode are used to modify the cast electrode substrate 110 at the anode.

Li/Ca/Ru/Ir/O cast electrodes may be formed directly in the molten salt bath. A ruthenium or iridium monolithic workpiece (i.e., substrate 110) may be subjected to anodic current in the molten salt bath, which includes a lithium salt, e.g., lithium chloride, and/or a calcium salt, e.g. calcium bromide, calcium oxide. The anode decomposes the lithium salt and/or the calcium salt. The Li ions and Ca ions then react with the Ru or Ir workpiece to form the cast electrode. In some embodiments, the molten salt bath includes lithium carbonate (Li₂CO₃) which generates Li₂O in the salt bath. The formed lithium oxide may then react with the workpiece at the anode.

In place of using monolithic Ru or Ir as the substrate, the molten salt bath may, alternatively, be used to plate Ir and/or Ru onto a workpiece. This may avoid the cost associated with obtaining monolithic Ru or Ir. The plated Ir or Ru may then be reacted as above to form the electrode. The molten salt bath for plating Ir or Ru may contain the auxiliary electrolyte. The auxiliary electrolyte may include a lithium salt, a sodium salt, a potassium salt, a cesium salt, and/or a rubidium salt. The auxiliary electrolyte may also be formed from bromides, iodides, and/or fluorides. The salt bath also includes a functional electrolyte, for example, iridium bromide or ruthenium iodide. The functional electrolyte may be a metal bromide and/or a metal iodide. The functional electrolyte may be at least about 60 wt. % of the salt bath. For example, the functional electrolyte may be about 80 wt. % of the salt bath.

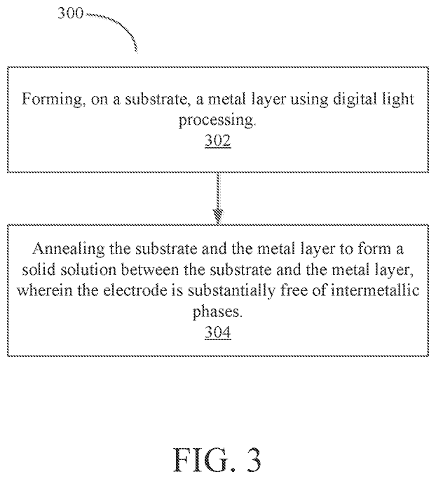

FIG. 3 is a flow diagram showing a process 300 according to embodiments of the disclosure. The process 300 includes the act 302 of forming, on a substrate, a metal layer using digital light processing. The process 300 also includes the act 304 of annealing the substrate and the metal layer to form a solid solution between the substrate and the metal layer, wherein the electrode is substantially free of intermetallic phases.

The substrate 110 and the metal layer 120 may be different materials. For example, the substrate 110 may be steel and the metal layer may be copper, nickel, or molybdenum. The process 300 may include forming multiple layers, e.g., additional metal layers on the metal layer, using digital light processing. This may provide a method to form an alloy by combining multiple layers of different materials until a desired thickness is achieved. The layers may have a thickness of greater than about 1 millimeter. The layers may have a thickness of under about 1 millimeter, for example, between about 10 micrometers and about 300 micrometers.

The process 300 also includes the act 304 of annealing the substrate 110 and the metal layer to form the solid solution 130 between the substrate 110 and the metal layer, wherein the electrode is substantially free of intermetallic phases. The annealing may be conducted in an inert atmosphere or in vacuum. The annealing may be conducted at a temperature between about 500° C. and about 600° C. for about 8 to about 16 hours. In some embodiments, the annealing is conducted for about 12 hours.

The printed electrodes are produced by printing with digital light processing (“DLP”). The electrode may include a first material as a substrate 110, onto which is printed a second material, for example, a metal. The metal may include, but is not limited to, copper, nickel, or molybdenum. The printed second material may include a plurality of layers. The printed material produced by DLP may be prepared at room temperature. This may reduce the thermal expansion/contraction of the printed DLP material. In some embodiments, the printed material produced by DLP is heated above room temperature. For example, the DLP fluid may be warmed to decrease its viscosity and enhance flow into the gap between a bottom of the tank and the accumulated layers of the part being printed.

To form the printed electrodes, the substrate 110 may be secured to a movable platform on the DLP system. The printed layer or printed layers of the second material may be formed on the substrate 110. The printed layers may comprise a green part which is heated and/or sintered to form the desired metal layer on the substrate 110. The green part may be sintered with the substrate 110. The sintering may produce the metal layer which is subsequently annealed with the substrate 110 to form the solid solution 130 between the substrate 110 and the metal layer 120.

The green part may be formed separately from the substrate 110. The green part may then be sintered to form a metal part. The metal part may then be joined with the substrate 110 in an anneal process. In some examples, the anneal process is conducted in an inert atmosphere or in vacuum. For example, the green part may be placed on the substrate 110 and the green part subjected to a sintering cycle followed by an annealing cycle to fuse the DLP prepared component with the substrate 110. The green part may include the second material, e.g., copper, which is fused as part of the sintering and annealing processes.

The second material of the printed electrode may alternately be printed as a metal oxide and then may be electro-chemically reduced in a molten salt bath to a metal. The molten salt bath may be maintained at a temperature of from about 800° C. to about 1000° C. The electrochemical reduction may use the cathode as the working electrode. The process may be conducted for a sufficient period of time to reduce the metal oxide to the metal such as, for example, about six hours to about twelve hours. In some embodiments, the time period for the process may be about eight hours. The reduction may, for example, be performed in a reducing oven which has hydrogen gas in an inert gas atmosphere. In an embodiment, the reduction process is begun in a reducing oven and then finished in a molten salt bath on the cathode.

With some materials, the metal oxide may be more easily printable than the corresponding metal. For example, printing titanium oxide may be easier than printing titanium metal. With such materials, the metal oxide is printed and then reduced to the desired metal. This reduction may be accomplished by connecting the metal oxide printed piece to the cathode in the molten salt bath that includes the auxiliary electrolyte. The molten salt bath may lack a functional electrolyte so that additional material is not plated while reducing the metal oxide. For example, a suitable salt bath may be a calcium chloride (CaCl₂) bath.

After the electrodes (e.g., the composite plated electrodes, the cast electrodes, or the printed electrodes) have been produced, the electrodes are annealed. Annealing diffuses the materials of the electrodes together to form the solid solution 130 characterized by the interlayer between the two (or more) materials. The two materials may be two different materials, such as silicon and a metal or two different metals. The interlayer may provide corrosion resistance to the electrode. The anneal may also close porosity in the interlayer. In some embodiments, the anneal is conducted at between about 500° C. and about 600° C. for about 8 to about 16 hours. The annealing is conducted in an inert atmosphere or in vacuum. The inert atmosphere may be a noble gas, e.g., argon, and/or helium gas, which is unreactive under the described conditions.

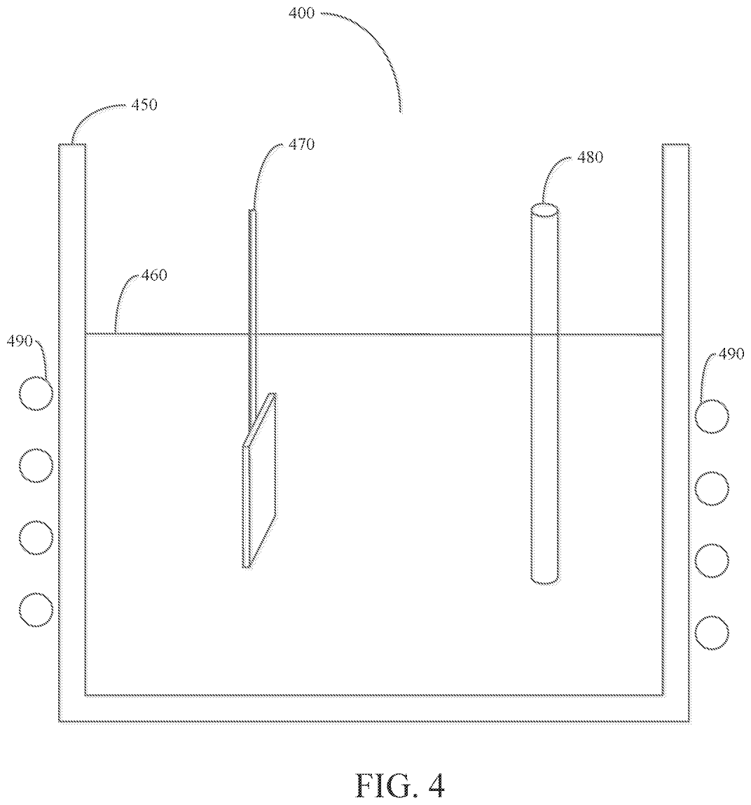

FIG. 4 shows an example of a system configured to form the electrodes 100 according to embodiments of the disclosure. The cell 400 includes a crucible 450 and/or other vessel to contain the molten salt plating bath 460. The crucible 450 may be formed from and include alumina, magnesia, graphite or may be a nickel-based material. The crucible 450 is positioned near a heater 490. The heater 490 provides heat to warm the crucible 450 and melt the contents (e.g., the electrolyte) of the crucible 450. The heater 490 may be a plurality of heaters 490. The use of more heaters 490 may decrease the time to heat the crucible 450 to a working temperature. The working temperature may be selected to melt the electrolyte in the crucible 450. The electrolyte makes up the molten salt plating bath 460 and may include the auxiliary electrolyte and the functional electrolyte.

The auxiliary electrolyte may include a lithium salt, a sodium salt, a potassium salt, a cesium and a rubidium salt. These salts are bromides, iodides, fluorides, or a mixture thereof. For example, the auxiliary electrolyte may include lithium bromide, potassium iodide, and cesium bromide. In another example, the auxiliary electrolyte may include lithium bromide, potassium bromide, and cesium fluoride. Yet in another example, the electrolyte may include a eutectic composition of lithium bromide, potassium bromide and cesium bromide. A variety of suitable auxiliary electrolytes may be formed by mixing different salts.

The system includes electrodes in order to plate the material. The electrodes include a working electrode 470, which corresponds to the substrate 110, and a counter electrode 480. The working electrode 470 may be the cathode, i.e., the negative electrode, during deposition of material onto the workpiece connected to the working electrode 470. The counter electrode 480 may be the anode, i.e., the positive electrode, while material is being deposited on the workpiece on the working electrode 470. In some cases, the working electrode 470 may be made positive to etch the workpiece. This may be done to clean the surface of the workpiece prior to plating a coating of the metal onto the workpiece. This may be done periodically during the deposition (e.g., as pulse plating) in order to help form a smooth and adherent plated coating to the workpiece.

The system may include an optional reference electrode. The reference electrode may be in electrical communication with the counter electrode 480 and the working electrode 470 and may be configured to monitor the potential difference between the counter electrode 480 and the working electrode 470. Accordingly, the reference electrode may be configured to monitor the cell potential of the cell 400.

The reference electrode may include nickel, nickel/nickel oxide, glassy carbon, silver/silver chloride, one or more platinum group metals, one or more precious metals (e.g., gold), or combinations thereof. The reference electrode may comprise glassy carbon. In other embodiments, the reference electrode comprises nickel, nickel oxide, or a combination thereof. In yet other embodiments, the reference electrode comprises silver/silver chloride. The use of a reference electrode may be helpful when characterizing the system, for example, during process development.

A potentiostat-galvanostat may be electrically coupled to each of the counter electrode 480, the working electrode 470, and the reference electrode. The potentiostat-galvanostat may be configured to measure and/or provide an electric current between the counter electrode 480 and the working electrode 470. The difference between the voltages of the counter electrode 480 and the working electrode 470 may be referred to as a cell voltage of the cell 400. The cell voltage/current may be used to control the plating parameters on the working electrode 470 and/or the counter electrode 480. For example, the cell voltage may be used to adjust the current applied to the working electrode 470.

The working electrode 470 comprises the substrate 110. The working electrode 470 receives the metal layer 120. The working electrode 470 is then annealed to form a solid solution 130 between the substrate 110 and the metal layer 120.

The counter electrode 480 may include a platinum group metal (PGM), a precious metal (e.g., silver or gold), or a combination thereof. By way of nonlimiting example, the counter electrode 480 may include ruthenium, osmium, rhodium, iridium, palladium, platinum, silver, gold, or combinations thereof. In some embodiments, the counter electrode 480 includes a ternary compound including a platinum group metal, oxygen, and one of an alkali metal and an alkaline earth metal. The ternary compound may have a general formula of M₁M₂Oₓ, wherein M₁ is one or more of lithium, sodium, potassium, magnesium, calcium, or strontium, M₂ is a platinum group metal such as ruthenium, osmium, rhodium, iridium, palladium, platinum, and combinations thereof, and x is an integer, such as 2, 3 or 4, depending on M₁. In other embodiments, M₂ may be tin or manganese. By way of nonlimiting example, the counter electrode 480 may comprise lithium iridate (Li₂IrO₃), lithium ruthenate (Li₂RuO₃), lithium rhodates (LiRhO₂, LiRhO₃), a lithium tin oxygen compound (e.g., Li₂SnO₃), a lithium manganese oxygen compound (Li₂MnO₃), calcium ruthenate (CaRuO₃), strontium ruthenium ternary compounds (SrRuO₃, Sr₂RuO₃, Sr₂RuO₄), calcium iridate (CaIrO₃), strontium iridate (SrIrO₃, SrIrO₄, Sr₂IrO₄), calcium platinate (CaPtO₃), strontium platinate (SrPtO₄), magnesium ruthenate (MgRuO₄), magnesium iridate (MgIrO₄), sodium ruthenate (Na₂RuO₄), sodium iridate (Na₂IrO₃), potassium iridate (K₂IrO₃), and potassium ruthenate (K₂RuO₄), and combinations thereof. In some embodiments, where the counter electrode 480 comprises a ternary compound, M₁ may be selected to comprise a material of the molten salt electrolyte. By way of nonlimiting example, where the molten salt electrolyte comprises lithium (e.g., LiCl/Li₂O), M₁ may be selected to be lithium. Similarly, where the molten salt electrolyte comprises calcium (e.g., CaCl₂/CaO), M₁ may be selected to be calcium.

The counter electrode 480 may comprise a monolithic material. In some such embodiments, the counter electrode 480 comprises a monolithic metal, such as monolithic iridium, monolithic ruthenium, monolithic osmium, monolithic rhodium, monolithic palladium, or monolithic platinum. In other embodiments, the counter electrode 480 comprises a monolithic structure of one of lithium iridate, lithium ruthenate, a lithium rhodate, a lithium tin oxygen compound, a lithium manganese compound, calcium ruthenate, a strontium ruthenium ternary compound, calcium iridate, strontium iridate, calcium platinate, strontium platinate, magnesium ruthenate, magnesium iridate, sodium ruthenate, sodium iridate, potassium iridate, potassium ruthenate, or combinations thereof.

The counter electrode 480 may comprise a monolithic body with a substantially uniform composition. In other embodiments, the counter electrode 480 may comprise a base material coated with counter electrode material formulated and configured to be substantially inert in the cell 400. The counter electrode 480 may comprise a base material plated with a material used to form a cast electrode, e.g., a platinum group metal.

The counter electrode 480 (e.g., anode) may include graphite, glassy carbon, nickel, cobalt, molybdenum, tantalum, tungsten, a platinum group metal, or another material. In an embodiment, the counter electrode includes graphite. Where the counter electrode 480 includes molybdenum, tantalum, tungsten, or combinations thereof, the electrolyte may include a bromide salt including at least one platinum group metal. In other embodiments, where the electrolyte comprises dissolved platinum group metals dissolved in a chloride salt, a fluoride salt, or a combination thereof, the counter electrode 480 may include graphite or glassy carbon. In further embodiments, where the counter electrode 480 comprises a platinum group metal, the electrolyte may comprise a bromide salt, an iodide salt, a fluoride salt, a chloride salt, or combinations thereof.

The counter electrode 480 may be made of the material being plated at the working electrode 470. For example, if the working electrode 470 is plating aluminum, the counter electrode 480 may be an aluminum rod, plate, foil, or other source of aluminum, such as aluminum alloys. If titanium is being plated on the working electrode 470, then the counter electrode 480 may be a titanium rod, plate, sheet, strip, foil, or an alloy of titanium, etc. The counter electrode may provide a source of ions to replace those being plated from the molten salt plating bath 460 to allow for more consistent bath chemistry during the plating process.

The system for electroplating includes the molten salt plating bath 460. The molten salt plating bath 460 includes an auxiliary electrolyte and a functional electrolyte. The auxiliary electrolyte includes a lithium salt, a potassium salt, a cesium salt, and a rubidium salt. The auxiliary electrolyte salts may be bromides, iodides, and/or fluorides. The auxiliary electrolyte may be a eutectic mixture of salts. The auxiliary electrolyte may make up about ten percent to about forty percent of the molten salt plating bath 460. For example, the auxiliary electrolyte may make up about twenty percent of the molten salt plating bath 460 with the other eighty percent being the functional electrolyte.

In some embodiments, the counter electrodes 480 may also be fabricated by a field-assisted sintering technique/spark plasma sintering (FAST/SPS) process. In this process, a substrate (e.g., a metal, such as titanium, molybdenum, tantalum, niobium or a non-metal, such as a graphite rod or silicon substrate) may be coated with an oxide mixture, such as ruthenium oxide, iridium oxide, lithium oxide, calcium oxide, lithium carbonate, or calcium carbonate. The coated substrate is compressed and exposed to current, where a very high temperature melts the oxide mixture, which then bonds with the substrate via a relatively fast-annealing process. The coating thicknesses may range from about several angstroms to about several millimeters. This provides an additional method to form composite electrodes.

### EMBODIMENTS

### Example 1

A molten salt electroplating bath was prepared with a functional electrolyte and an auxiliary electrolyte. The functional electrolyte included aluminum bromide (AlBr₃) and accounted for about 80% of the molten salt electroplating bath. The auxiliary electrolyte accounted for the other about 20% of the molten salt electroplating bath and included a eutectic mixture of lithium bromide, potassium bromide, and cesium bromide. The molten salt electroplating bath was heated to about 350° C. The molten salt electroplating bath was heated to temperature inside an inert gas glovebox having an argon atmosphere.

Parts (e.g., substrates) to be plated were cleaned using acetone and dried in an oven overnight. The parts were then attached to the cathode for plating. The plating was conducted using a current density of about 0.5 A/cm². The time for plating was about 30 minutes to about 120 minutes. The parts included iron, copper, and brass parts which were plated with aluminum using an all bromide molten salt plating bath.

The resulting iron-aluminum, copper-aluminum, and brass-aluminum parts were diffusion bonded and showed no sign of degradation in highly acidic solutions for a period of over 200 hours.

A portion of the surface aluminum diffused to the bulk and chemically reacted to form a predominantly solid solution with the substrate. The in situ formed diffused metallic interlayer was determined to protect the substrates (e.g., steel, copper, and brass) from chemical degradation by the chloride and hydrogen ions respectively, present in a 5% sodium chloride in water test solution as room temperature. In contrast, un-plated control substrates showed accelerated corrosion in the 5% sodium chloride test solution.

### Example 2

A substrate is selected, cleaned, and attached to the digital light processing (DLP) additive manufacturing system. The substrate is a metal or metalloid. An electrode design is provided to the DLP system. The DLP system is loaded with a metallic resin. Such resins are available from commercial suppliers of DLP systems. The resin includes a metal, such as copper, molybdenum, or nickel, and a polymer used to fuse together and form a green part. The resin is used to fill a tank.

The DLP system emits a light through the bottom of the tank containing the resin. The light reacts with the resin to form a layer of green part on the substrate. The DLP system then increments the substrate upwards by the layer thickness, and repeats the process, forming sequential layers of green part attached to the substrate. This continues until the desired thickness of the green part is achieved.

The green part and substrate are removed from the DLP system. The green part and substrate are then baked in an oven to consolidate the green part. The substrate and consolidated green part are then annealed to form a solid solution between the substrate and the consolidated green part.

While embodiments of the disclosure may be susceptible to various modifications and alternative forms, specific embodiments have been shown by way of example in the drawings and have been described in detail herein. However, it should be understood that the disclosure is not limited to the particular forms disclosed. Rather, the disclosure encompasses all modifications, variations, combinations, and alternatives falling within the scope of the disclosure as defined by the following appended claims and their legal equivalents.

1. An electrode comprising:
a substrate;
a metal layer on the substrate; and
a solid solution between the metal layer and the substrate.

2. The electrode of claim 1, wherein the substrate comprises iron and the metal layer comprises aluminum.

3. The electrode of claim 1, wherein the substrate comprises silicon and the metal layer comprises aluminum.

4. The electrode of claim 1, wherein the substrate comprises iron and the metal layer comprises chromium.

5. The electrode of claim 1, wherein the electrode is substantially free of noble metals.

6. The electrode of claim 1, wherein the electrode is substantially free of intermetallic phases.

7. A method of forming an electrode comprising:
forming a molten salt bath;
plating, from the molten salt bath, a metal onto a substrate; and
annealing the metal and the substrate to form an electrode comprising a solid solution between the metal and the substrate, wherein the electrode is substantially free of intermetallic phases. cm 8. The method of claim 7, wherein plating, from the molten salt bath, a metal onto a substrate comprises plating the metal at a temperature between about 350° C. and about 450° C.

9. The method of claim 7, wherein forming a molten salt bath comprises forming the molten salt bath to be substantially free of chlorides.

10. The method of claim 7. wherein forming the molten salt bath comprises:
forming the molten salt bath with a combination of auxiliary salts selected from the group consisting of KBr, KI, LiBr, LiI, CsBr, CsI, RbBr, and RbI; and
forming the molten salt bath with at least 60 wt % of a metal salt, wherein the metal salt is a bromide or an iodide.

11. The method of claim 7, wherein forming the molten salt bath consists of:
forming the molten salt bath with a combination of auxiliary salts selected from the group consisting of KBr, KI, LiBr, CsBr, and CsI; and
forming the molten salt bath with at least 60 wt. % of a metal salt, wherein the metal salt is a bromide or an iodide.

12. The method of claim 7, wherein annealing the metal and the substrate comprises conducting the annealing between about 500° C. and about 600° C. for between about 8 hours and about 16 hours.

13. The method of claim 7, wherein annealing the metal and the substrate comprises conducting the annealing in an inert atmosphere or in a vacuum.

14. A method of forming an electrode comprising:
forming, on a substrate, a metal layer using digital light processing; and
annealing the substrate and the metal layer to form a solid solution between the substrate and the metal layer, wherein the electrode is substantially free of intermetallic phases.

15. The method of claim 14, wherein forming, on a substrate, a metal layer using digital light processing comprises forming a metal layer comprising copper, nickel, or molybdenum.

16. The method of claim 14, wherein annealing the substrate and the metal layer to form a solid solution between the substrate and the metal layer comprises conducting the annealing in an inert atmosphere or in a vacuum.

17. The method of claim 14, wherein annealing the substrate and the metal layer to form a solid solution between the substrate and the metal layer comprises annealing at between about 500° C. and about 600° C. for about 8 hours to about 16 hours.

18. The method of claim 14 further comprising forming a second metal layer on the metal layer using digital light processing.

19. The method of claim 14, wherein forming, on a substrate, a metal layer using digital light processing comprises forming the metal layer comprising a thickness of less than about 1 millimeter.

20. The method of claim 14, wherein forming, on a substrate, a metal layer using digital light processing comprises forming the metal layer comprising a thickness between about 10 micrometers and about 300 micrometers.
